(19) United States
(12) Patent Application Publication
(10) Pub. No.: US 2011/0072886 A1
(43) Pub. Date: Mar. 31, 2011

(54) Gas Sensor Based On Photoacoustic Detection

(76) Inventors: Catherine Genevieve Caneau, Corning, NY (US); Anping Liu, Big Flats, NY (US); Scott Christopher Pollard, Big Flasts, NY (US); Feng Xie, Painted Post, NY (US); Chung-En Zah, Holmdel, NJ (US)

(21) Appl. No.: 12/570,606

(22) Filed: Sep. 30, 2009

(51) Int. Cl. G01N 21/00

(52) U.S. Cl. 73/24.02

(57) ABSTRACT

A photoacoustic gas detector and photoacoustic gas detection method are disclosed. The detector includes a laser source, an acoustic resonator, and at least one tuning fork positioned along a longitudinal length of the resonator. The detector is capable of performing fast measurements of the concentration of one or more target gases over a broad temperature range.

### BACKGROUND

The disclosure relates generally to gas sensors, and particularly to methods and devices for detecting one or more target gas concentrations using photoacoustic detection techniques.

Detection and quantification of trace gases and chemical species are becoming increasingly important for diverse applications such as environmental monitoring, industrial process control, and medical diagnostics. Currently, a number of ultrasensitive detection techniques based on molecular absorption in the mid-IR region are capable of measuring chemical species at low concentration levels, but most methods are only demonstrated in a laboratory environment. They are either too bulky to be carried in the field or too expensive to be widely used. In addition, they are typically based on complicated and delicate optical setups which require high precision alignment and are sensitive to vibrations and temperature variations.

For example, optical spectroscopy is capable of demonstrating high sensitivity and selectivity when an adequate photodiode is used for detecting laser power losses due to accumulated absorption of the molecule in a sufficiently long optical path. However, to suppress noise, the photodiode has to be cooled in liquid nitrogen. As a result, the instrument is limited to laboratory environment and thus not suited for real field application.

Photoacoustic detection provides an alternative to optical spectroscopy by replacing the photodiode or detector used in optical spectroscopy with an acoustic detector. In photoacoustic detection, the excitation energy of light absorbing molecules is essentially transferred into kinetic energy to the surrounding molecules via inelastic collisions. This causes a local pressure increase in the absorbing gas. If the excitation source is modulated, a sound wave is generated and can be detected by an acoustic detector, typically a microphone. Because the amount of absorbed energy is proportional to the concentration of the absorbing molecules, the acoustic signal can be used for accurate concentration measurements. Photoacoustic detection uses a much smaller sample volume than optical spectroscopy while achieving comparable detection limits. However, photoacoustic detection using a microphone to detect acoustic signal produced by gas absorption can detect an undesirable amount of ambient noise relative to the signal generated from the absorbing gas. This is, in large part, due to the generally broad band response of microphones.

Alternatives to microphones in photoacoustic detection include tuning forks that are widely available in the electronics industry. However, previous approaches involving tuning forks have required a sharply focused laser beam to pass through the tuning fork prongs. In other words, such approaches have required the laser beam to be aligned in the middle of the slot formed by the two prongs of the tuning fork. This configuration makes it difficult to use a plurality of tuning forks for either performance improvement or achieving simultaneous multiple-gas detection since the beam size changes dramatically over a short distance, such that one or more tuning forks may partially block the beam and induce unwanted interference. Implementation of multiple tuning forks in the optical path therefore requires a more complicated configuration, resulting in a longer optical path and a tighter optical tolerance. Consequently, device performance can be substantially deteriorated and the cost and size can be increased.

### SUMMARY

One embodiment includes a photoacoustic gas detector for detecting the concentration of at least one target gas. The gas detector includes a laser source and a resonator extending along a longitudinal axis. The resonator includes a first end, a second end, and an inner cavity between the first end and the second end. The inner cavity extends along the longitudinal axis and defines a longitudinal opening between the first end and the second end. The inner cavity is adapted to allow a laser beam from the laser source to pass through the longitudinal opening. The gas detector also includes at least one tuning fork positioned along a longitudinal length of the resonator. The tuning fork includes a first prong and a second prong. The longitudinal axis does not intersect an area between the first prong and the second prong.

Another embodiment includes a method for determining the concentration of at least one target gas using photoacoustic detection. The method includes directing a light beam from a laser source into an inner cavity of a resonator. The resonator and the inner cavity extend along a longitudinal axis and the inner cavity contains a concentration of the at least one target gas. Interaction between the laser beam and the at least one target gas causes accumulation of an acoustic signal in the resonator. The method also includes generating a resonant absorption signal relative to the concentration of the at least one target gas by at least one tuning fork positioned along a longitudinal length of the resonator. The tuning fork includes a first prong and a second prong, wherein the longitudinal axis does not intersect an area between the first prong and the second prong.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description present exemplary embodiments, and are intended to provide an overview or framework for understanding the nature and character of the claims. The accompanying drawings are included to provide a further understanding, and are incorporated into and constitute a part of this specification. The drawings illustrate various embodiments, and together with the description serve to explain the principles and operations of the various embodiments.

### BRIEF DESCRIPTION OF THE DRAWINGS

FIG. 1 illustrates a schematic diagram of a photoacoustic gas detector as disclosed herein;

FIG. 2 illustrates a perspective view of components of the photoacoustic gas detector illustrated in FIG. 1;

FIGS. 3A-3F illustrate cross-sectional views of alternative configurations of photoacoustic gas detector components;

FIGS. 4A and 4B illustrate cross-sectional side and end views additional alternative configurations of photoacoustic gas detector components;

FIGS. 5A and 5B illustrate cross-sectional views of yet additional alternative configurations of photoacoustic gas detector components;

FIGS. 6A and 6B plot theoretical absorption spectrum and measured absorption spectrum of a target substance;

FIG. 7 plots concentration of water vapor measured as a function of time by a photoacoustic gas detector as disclosed herein;

FIG. 8 plots concentration of C₂H₂ measured as a function of time by a photoacoustic gas detector as disclosed herein; and

FIG. 9 plots nitric oxide (NO) absorption over a specified tuning range.

### DETAILED DESCRIPTION

Reference will now be made in detail to the present preferred embodiments, examples of which are illustrated in the accompanying drawings.

Disclosed herein is a photoacoustic gas detector and method, in which a trace gas absorbs energy from a laser beam and the absorbed energy of the gas is accumulated in an acoustic detector that includes a resonator and at least one tuning fork. The laser source preferably has a very narrow linewidth, normally operates in a single longitudinal mode, and has a wavelength that is selected to match a specific absorption peak of the gas so that only the gas of interest absorbs the laser energy. In other words, other gases have little to no absorption at the selected wavelength and thus do not substantially absorb the laser energy. Preferably, the laser source produces at least one emission wavelength with a spectral linewidth narrower than the absorption bandwidth of the gas. In addition, the laser source is preferably capable of tuning its wavelength to find the absorption peak of the gas. Once the gas absorbs the laser energy, the energy can dissipate into the environment surrounding the molecule and cause expansion or contraction of materials in the environment. When the laser is modulated at an acoustic frequency, the materials expand and contract at the same frequency. As a result, sound waves are generated and can be detected by acoustic detectors. Compared with a conventional photoacoustic detection technique that uses an ambient noise sensitive microphone, the current invention uses an acoustic detector operating at its resonance frequency that is synchronized to the laser modulation frequency. This configuration allows the device to be substantially immune to ambient noise so as to be suited for harsh environments, such as automobile applications.

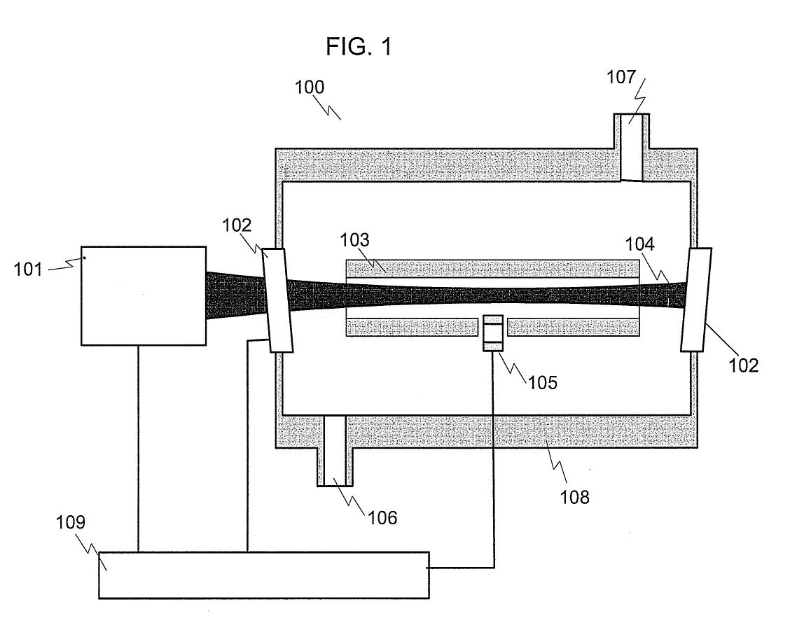

A schematic diagram of an embodiment of a photoacoustic gas detector is illustrated in FIG. 1. Detector 100 includes a laser source 101, a gas cell 108 with two windows 102, an acoustic resonator 103, a tuning fork 105, and a data acquisition and control unit 109. The gas to be detected enters gas cell via an inlet port 106 and exits via outlet port 107. The gas concentration is measured by detecting the signal strength of a tuning fork 105.

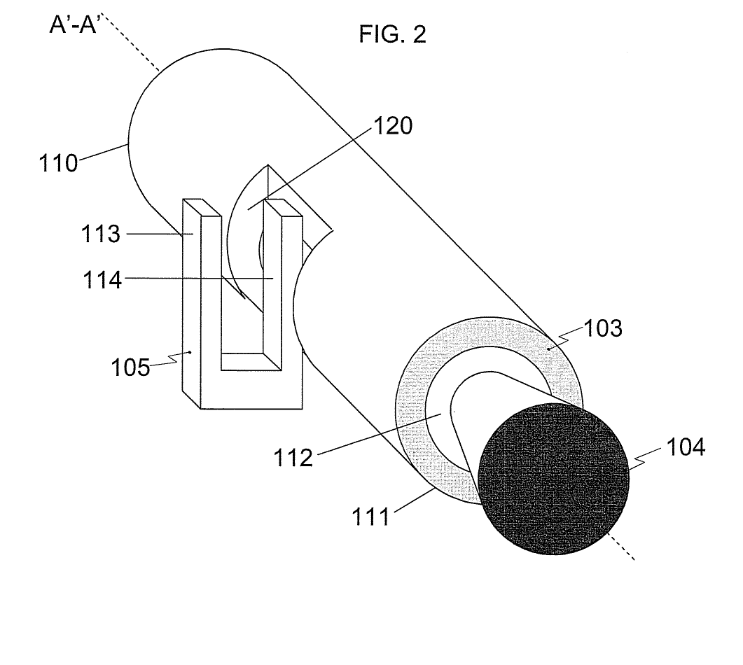

FIG. 2 illustrates a perspective view of components of the photoacoustic gas detector illustrated in FIG. 1. As shown in FIG. 2, resonator 103 extends along a longitudinal axis A′-A′. Resonator 103 includes first end 110, second end 111, and an inner cavity 112 extending between the first end 110 and the second end 111, the inner cavity 112 extending along the longitudinal axis A′-A′ and defining a longitudinal opening between the first end 110 and the second end 111. The inner cavity 112 is adapted to allow a laser beam 104 from the laser source 101 to pass through the longitudinal opening. Tuning fork 105 is positioned along a longitudinal length of the resonator 103 and includes a first prong 113 and a second prong 114. Longitudinal axis A′-A′ does not intersect an area between first prong 113 and second prong 114.

In this configuration, the laser beam 104 is well aligned along the resonator 103 so that it passes the resonator without inducing any substantial amount of loss from the resonator internal surface. As the laser is tuned to the gas absorption peak, the relatively strong gas absorption creates local heating in the resonator 103. The local heating is directly proportional to the laser power. When the laser power is modulated, the local heating follows the laser power and results in gas expansion and contraction. This pressure change in the resonator 103 forces the tuning fork 105 to vibrate. The vibration of the tuning fork 105 results in an electric charge on the tuning fork due to piezoelectric effect and can be measured with the data acquisition and control unit 109.

Alternatively stated, inner cavity 112 of resonator 103 contains a concentration of at least one target gas, wherein interaction between the laser beam 104 and the at least one target gas causes accumulation of an acoustic signal in the resonator 103. A resonant absorption signal relative to the concentration of the target gas is generated by tuning fork 105.

Tuning fork 105 has a shape similar to that of a conventional tuning fork widely used for calibrating musical instruments and resonates at a specific constant pitch when it is struck. The pitch that a particular tuning fork generates largely depends on the length of prongs 113 and 114. The vibration frequency of tuning fork 105 is determined by its dimensions and the material from which it is made. In a preferred embodiment, tuning fork 105 is made from piezoelectric materials which generate an electric potential in response to applied mechanical stress. Quartz is a widely used piezoelectric crystal for mass production of tuning forks. Due to abundant availability and stability, a quartz tuning fork with a resonance frequency close to 32,768 Hz is commonly used as a frequency standard in clocks and watches. Beside quartz, gallium orthophosphate (GaPO₄) and Langasite (lanthanum gallium silicate, LGS) La₃Ga₅SiO₁₄ are piezoelectric crystals. GaPO₄ crystal belongs to the same crystal class as quartz. Silicon atoms (Si) are alternately replaced by gallium (Ga) and phosphorus (P) atoms, respectively. GaPO₄ keeps its piezoelectric properties up to 970° C., much higher than the Curie point of quartz (573° C.). GaPO₄ also has a higher piezoelectric coefficient. Compared with quartz and GaPO₄, LGS can operate at yet higher temperature since it has no phase transition up to its melting point of 1470° C. Such high operation temperature is especially beneficial for applications in automobile combustion control, in which a NOx sensor monitors the NO and NO₂ concentrations of exhaust gases and feeds their concentration values back to a computer to control engine operation conditions so that the engine can minimize NOx production.

Tuning fork 105 is designed to operate in flexural vibration mode though it can also operate in torsion modes. In the flexural vibration mode, the two prongs 113 and 114 vibrate on the same plane but in opposite directions. Electrodes are coated on the prong surfaces with a specific configuration so that they detect electric potential change due to vibrations in this specific direction. Since the piezoelectric effect is reversible, the tuning fork prongs 113 and 114 can move in the opposite directions when an electric potential is applied to the electrodes. When a potential signal having the same frequency as the tuning fork resonance frequency is applied to the tuning fork 105, the vibration of the prongs reaches a maximum. In other words, when the tuning fork is used to measure an acoustic wave, it is desirable to match the acoustic wave frequency with the tuning fork resonance frequency because in this case the signal strength reaches a maximum. The width of the tuning fork resonance frequency at normal pressure is less than 10 Hz, therefore only frequency components in this narrow spectral band can contribute to efficient excitation of the tuning fork vibration.

The use of a tuning fork 105 allows the detector 100 to be substantially immune to background acoustic noise as a result of that the operation frequency of the tuning fork being selected to be far away from the background acoustic noise frequency, which can range from a few Hz to 20 kHz. In most situations, background acoustic noise density is inversely proportional to its acoustic frequency and is typically very low above 10 kHz. Therefore, the higher the operating frequency of the tuning fork, the less background noise it detects. At the same time, the tuning fork operating frequency should be selected to adequately respond to absorption of laser energy by the target gas. Such energy absorption varies for different gases. For most gases, the tuning fork should be preferably operated at a frequency of over several to tens of kHz. Preferably, the operating frequency of the tuning fork should be selected to be higher than 20 kHz for adequate response and noise suppression. For example, when a commercial off-the-shelf tuning fork operating at 32 kHz is used, the acoustic wavelength in air is about 10 mm. The sound waves from a distant source tend to apply a force in the same direction to each of the two prongs positioned about 0.5 mm apart. This does not excite the piezoelectrically active mode and does not result in a measurable electric signal.

Resonator 103 acts to increase an effective interaction length between tuning fork 105 and acoustic waves generated as a result of interaction between the laser beam 104 and the target gas. When the resonator is filled with gas, the acoustic wave signal S can be expressed as:

$$S = k \frac{α l C P Q}{f V}$$

Where α is the absorption coefficient of the target gas, l is the gas absorption length, C is the concentration of the target gas, P is the optical power, Q is the quality factor of the resonator, f is the photoacoustic sound frequency, V is the resonator volume, and k is a constant describing microphone transfer function and other system parameters. For a conventional photoacoustic resonator using a microphone as an acoustic detector, due to limitations of microphone response, the resonators are designed for f values in the 500 to 4,000 Hz range with Q factors of about 20 to about 200 and volumes starting from about 10 cm³. For a tuning fork based resonator, the resonator volume V can be as small as 1 mm³ and the Q factor is in the range of about 10⁴ to about 10⁵. In addition, due to the specific frequency response of the tuning fork, the noise level of the detector can be expected to be at least 100 times lower than that of a conventional photoacoustic sensor. As a result, a tuning fork based sensor can, for example, be about 100 to about 1000 times more sensitive than a conventional photoacoustic sensor.

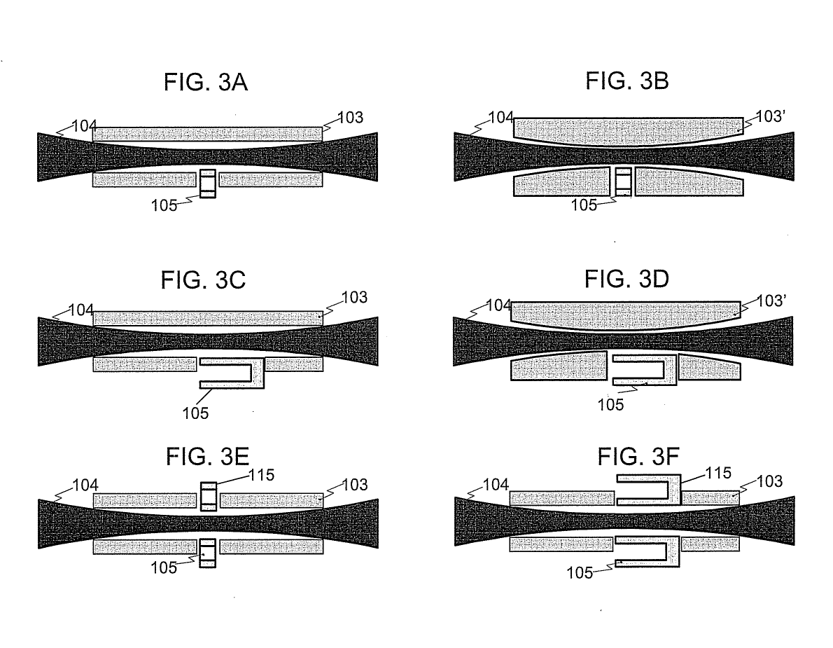

FIGS. 3A-3F illustrate cross-sectional views of alternative configurations of photoacoustic gas detector components. Since sensitivity is inversely proportional to resonator volume as indicated in the above expression, it is desirable to make the resonator as small as possible without inducing any substantial amount of loss to the laser beam 104 from the resonator internal surface. FIGS. 3A, 3C, 3E and 3F illustrate a cylindrical resonator 103 with an approximately constant internal diameter. Cylindrical resonators with a constant internal diameter can be made easily from commercially off-the-shelf tubes and thus can provide a cost effective approach. By comparison, a resonator 103′ having an inner diameter that decreases from an end to the midpoint of the resonator along its longitudinal length such that the internal diameter is slightly greater (i.e. the tube diameter is 1.2˜1.5× larger than laser beam 104) than the focused Gaussian laser beam 104 along the longitudinal length, as illustrated in FIGS. 3B and 3D, can provide even a smaller internal volume and can be used for sensors requiring very high sensitivities. A variety of materials, including but not limited to glass, metal, and plastic, may be used to make the resonator. To mitigate surface loss of acoustic waves, the resonator inner surface is preferably smooth. In addition, the dimension and shape of the resonator is preferably optimized so that its eigen-frequency (i.e. resonance frequency) matches the tuning fork resonance frequency for achieving enhanced sensitivity. For example, in the case of a cylindrical tube resonator with an approximately constant inner and outer diameter, the resonance frequency is related to the length of the cylindrical tube and whether it has closed or open ends. For a two-end open cylindrical resonator, the resonance frequency can be expressed as

$$f = \frac{n v}{2 L} ,$$

where n is a positive integer (1, 2, 3 . . . ) representing the resonance node, L is the length of the tube, and v is the speed of sound in air (which is approximately 343 m/s at 20° C. and at sea level). In a preferred embodiment, n=1. Notably, the above expression relates specifically to a cylindrical tube resonator having an approximately constant inner and outer diameter. Other resonator geometries would correspond to different expressions.

Preferably, resonator 103 or 103′ has a structural resonance frequency that substantially coincides with a structural resonance frequency of tuning fork 105.

In preferred embodiments, tuning fork 105 is located along one side of longitudinal axis A′-A′ approximately halfway along the longitudinal length of the resonator, as illustrated, for example, in FIGS. 2 and 3A. Alternatively, tuning fork 105 may be located along one side of longitudinal axis A′-A′ proximate to a first or second end of the resonator (not shown). While both prongs 113 and 114 of tuning fork 105 are located along one side of the longitudinal axis, one prong is preferably closer to the longitudinal axis than the other. As shown in FIGS. 1-2 and 3A-3F, a notch or opening (shown as 120 in FIG. 2) can be provided in the resonator along one side of the longitudinal axis into which a prong 114 of tuning fork 105 extends. Notch or opening 120 can extend into inner cavity of resonator 103 or 103′ and at least a portion of a prong 114 of tuning fork 105 can extend within the resonator inner cavity.

Prongs of tuning fork 105 can, for example, be generally perpendicular to longitudinal axis A′-A′ (FIGS. 3A-3B) or generally parallel to longitudinal axis A′-A′ (FIGS. 3C-3D). In further alternative embodiments (not shown), tuning fork 105 may be tilted at an angle that is not generally perpendicular or parallel to longitudinal axis A′-A′. In any event, the tip of prong closest to longitudinal axis A′-A′ is preferably sufficiently close to laser beam 104 so as to achieve maximum signal strength without inducing loss or scattering of laser beam 104. Photoacoustic waves resulting from interaction between laser beam 104 and target gas cause the prongs to vibrate in their resonance direction, resulting in electric charge due to piezoelectric effect.

Photoacoustic gas detectors as disclosed herein may include more than one tuning fork. For example, by adding a second tuning fork, applicants have discovered that measurement speed may be increased by a factor of two. The presence of an additional tuning fork can be particularly useful for some gases having a slow vibration-translation (V-T) relaxation and for applications that require an especially rapid response. For example, the detector can include a second tuning fork 115 such that two tuning forks are located on the same plane approximately halfway along the longitudinal length of the resonator on opposite sides of laser beam 104 extending along longitudinal axis A′-A′, as shown for example in FIG. 3E. Prongs of tuning forks 105 and 115 can, for example, be generally perpendicular to longitudinal axis A′-A′ (FIG. 3E) or generally parallel to longitudinal axis A′-A′ (FIG. 3F). In further alternative embodiments (not shown), tuning forks 105 and 115 may independently be tilted at an angle that is not generally perpendicular or parallel to longitudinal axis A′-A′. When tuning forks 105 and 115 are not located on the same plane approximately halfway along the longitudinal length of the resonator, a calibration algorithm may be used to correct for the differences of their locations. When two or more tuning forks are used, they should preferably be positioned next to each other to reduce measurement errors caused by location differences.

In addition to increasing measurement speed, the use of two or more tuning forks can also improve measurement accuracy. The absorption coefficient for any gas depends on both temperature and pressure. Accordingly, preferred measurement methods include generation of a resonant absorption signal relative to the concentration of the at least one target gas while calibrating for the temperature and pressure in the inner cavity of the resonator.

Such calibration can be accomplished through utilization of at least a second tuning fork. Tuning fork resonance frequency is a function of pressure and temperature and, as a result, temperature and pressure in the inner cavity of the resonator can be determined by sending a series of electric probing pulses from the electric control unit into the tuning fork. When the frequency of the probing pulse matches the tuning fork resonance frequency, the tuning fork generates a maximum signal output. By measuring resonance frequency change over time, changes in gas temperature and pressure conditions can be accounted for and used to calibrate gas concentration measurement results. In such a case, at least two tuning forks operate simultaneously. At least a first tuning fork is measuring the amount of laser beam absorption by the target gas while at least a second tuning fork is monitoring the pressure or temperature of the gas by measuring its resonance frequency. The measured pressure or temperature then is used to calibrate the measured target gas concentration.

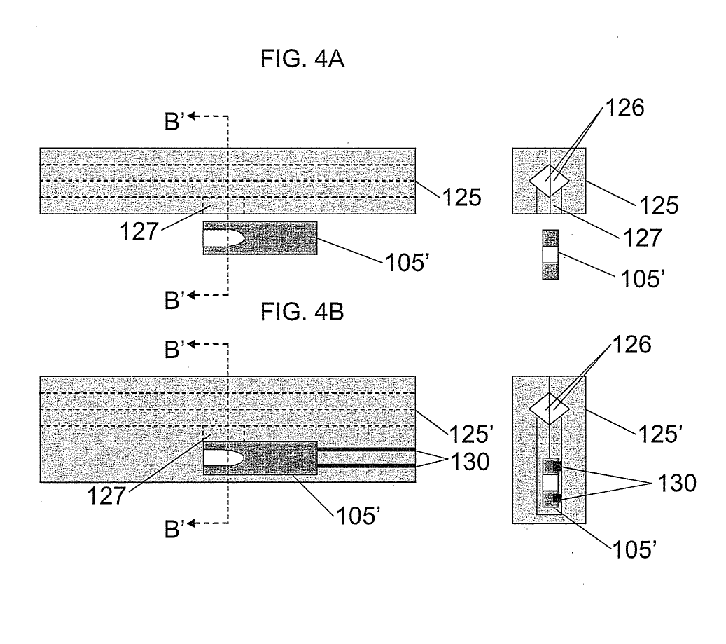

FIGS. 4A and 4B illustrate cross-sectional side and end views of alternate embodiments of tuning fork and resonator. As shown in FIG. 4A, resonator 125 includes an inner cavity comprising two V-shaped grooves 126 that can, for example, be cut or etched into separate sides of resonator material, using, for example, conventional semiconductor fabrication processes. A preferred resonator material for this embodiment is silicon. Separate sides of resonator material can then be brought together such that when V-shaped grooves 126 face each other, inner cavity extending along the longitudinal length of resonator 125 results. V-shaped grooves 126 can have constant or variable cross-sectional dimensions over their lengths and alternative embodiments (not shown) can have cross-sectional shapes other than V-shapes (such as L-shapes or U-shapes). Tuning fork 105′ is preferably positioned along a longitudinal length of resonator 125 sufficiently close to resonator 125 so as to effectively generate a resonant absorption signal relative to the concentration of the target gas. Preferably, tuning fork 105′ prongs are located approximately halfway along the longitudinal length of the resonator such that prongs are intersected by B′-B′, which represents the halfway point between first and second resonator ends. Preferably, resonator 125 also includes opening 127 that is also intersected by B′-B′ such that at least a portion of tuning fork 105′ prongs extend along the same portion of longitudinal length of resonator 125 as opening 127. FIG. 4B shows an embodiment in which tuning fork 105′ and resonator 125′ are integrated on a single platform. Electrical leads 130 extend from tuning fork 105′ to, for example, a data acquisition and control unit.

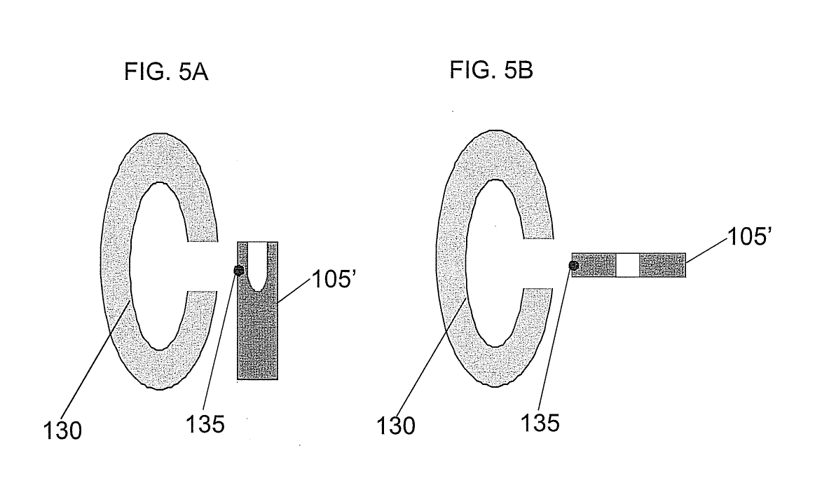

FIGS. 5A and 5B illustrate cross-sectional views of further alternative embodiments wherein resonator 130 has a parabolic cross-section. Tuning fork 105′ is at least partially positioned on a focal point 135 of the parabolic cross section. In FIG. 5A, tuning fork prongs are generally perpendicular to a longitudinal axis of resonator 130. In FIG. 5B, tuning fork prongs are generally parallel to a longitudinal axis of resonator 130.

Referring back to FIG. 1, wavelength of laser beam 104 from laser source 101 is selected as a function of absorption characteristics of the target gas. The wavelength of laser beam 104 can be in a very broad range, from ultra-violet (UV) to mid-infrared (IR). In general, most gases absorb wavelengths in the mid-IR (approximately 4000-400 cm⁻¹ or 2.5-25 μm) more strongly than wavelengths in the near-IR (approximately 14000-4000 cm⁻¹ or 0.714-2.5 μm). To achieve better sensitivity, it is preferred to use mid-IR lasers.

Laser source 101 can be packaged within the detector 100 or remotely located to deliver the laser beam into the resonator 103 via, for example, an optical fiber. To create a series of sound waves, characteristics of laser beam 104 can be controlled so that the energy absorbed by the gas in the resonator varies over time. This can be implemented, for example, by modulating the laser power (i.e. amplitude modulation) or its wavelength (i.e. wavelength modulation).

Data acquisition and control unit 109 can serve at least two purposes. First, it can control laser operation parameters such as temperature, wavelength, modulation, and output power. Second, it can measure the electric charge from the tuning fork. Preferably, the laser is wavelength modulated at a frequency of f/2 in order to suppress background noise generated from spectrally nonselective absorbers such as resonator wells, optical windows, and tuning fork surfaces. The signal from the tuning fork is preferably amplified, such as with a conventional lock-in amplifier operating at the tuning fork resonance frequency. An example of a data acquisition unit that may be used with embodiments disclosed herein consists of a function generator, a lock-in amplifier, and a personal computer.

Methods disclosed herein can be used for measuring the concentration of one or more target gases. When measuring for the concentration of at least two target gases, the detector preferably includes at least one tuning fork, and more preferably at least one tuning fork for each target gas to be measured. The tuning forks may each have about the same or slightly different resonance frequencies. When measuring for the concentration of at least two target gases, laser source 101 is preferably capable of generating a laser beam 104 at wavelengths that are selected as a function of the absorption characteristics of each target gas. In a preferred embodiment, a laser beam 104 at a predetermined wavelength is generated for each target gas. Preferably, the laser beams are combined using conventional wavelength division multiplexing (WDM) techniques so that they are collinear and pass through a single longitudinal opening in the same resonator. Such techniques can allow for a broad range of gases to be detected.

Preferably, detector 100 is capable of detecting at least one target gas at a concentration of less than 200 parts per million, more preferably at a concentration of less than 100 parts per million, and even more preferably at a concentration of less than 50 parts per million, and yet even more preferably at a concentration of less than 25 parts per million, and still yet even more preferably at a concentration of less than 10 parts per million

Methods using detector 100 are preferably able to generate a resonant absorption signal relative to the concentration of at least one target gas that is at least 10 times greater than a background noise signal, such as at least 50 times greater than a background noise signal, and further such as at least 100 times greater than a background noise signal, and yet even further such as at least 200 times greater than a background noise signal.

Methods using detector 100 are preferably able to generate a resonant absorption signal relative to the concentration of at least one target gas within three seconds of first directing a laser beam from a laser source into the inner cavity of the resonator, such as within two seconds of first directing a laser beam from a laser source into the inner cavity of the resonator, and further such as within one second of first directing a laser beam from a laser source into the inner cavity of the resonator.

Methods using detector 100 are preferably capable of generating a resonant absorption signal relative to the concentration of at least one target gas at a temperature of at least 300° C., such as at least 500° C., and further such as at least 700° C.

### EXAMPLES

Embodiments disclosed herein are further clarified by the following examples.

### Example 1

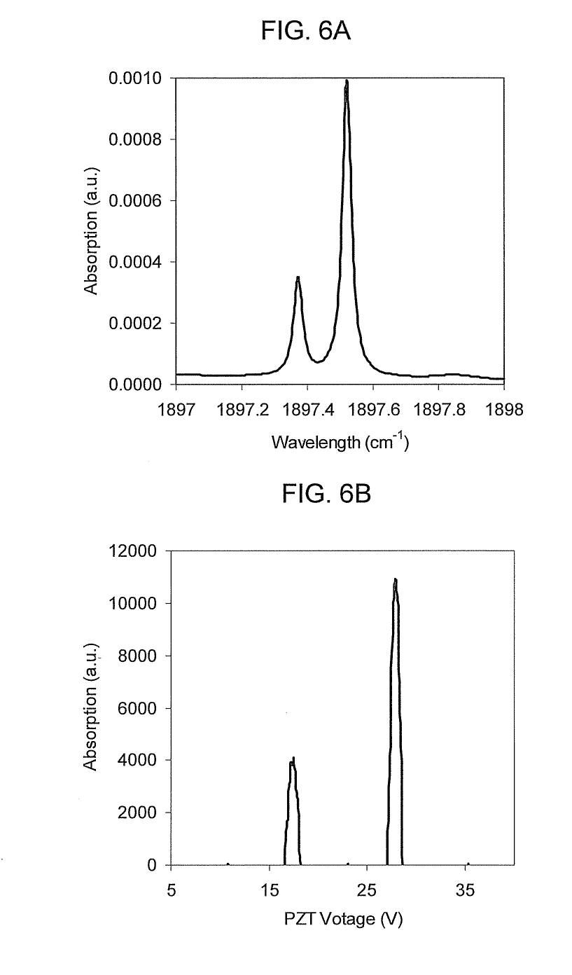

A photoacoustic gas detection system included a tunable quantum cascade laser as a laser source, an acoustic resonator, a tuning fork, and a data acquisition and control unit. The tunable laser was capable of changing its wavelength with a piezo-controller. The tuning fork was a commercial off-the-shelf component having a resonance frequency at 2¹⁵ (32768) Hz and the acoustic resonator was a stainless steel tube having an inner diameter of 0.8 mm and length of 10 mm. The tuning fork was aligned relative to the resonator in a manner similar to that illustrated in FIG. 2. The laser beam was focused into the resonator with an optical lens. During the measurement, the control unit modulated the laser power at ˜32768/2=16384 Hz while slowly changing its wavelength. The data acquisition unit, which included a function generator and lock-in amplifier, collected the electric signal from the tuning fork. FIG. 6A shows a theoretical water vapor absorption spectra showing two absorption peaks and FIG. 6B shows water vapor absorption spectra as measured by the system operating in open air. As can be seen from these figures, the detection system successfully found the two adjacent absorption peaks with a very good signal to noise ratio and very good agreement between the theoretical and measured spectra.

### Example 2

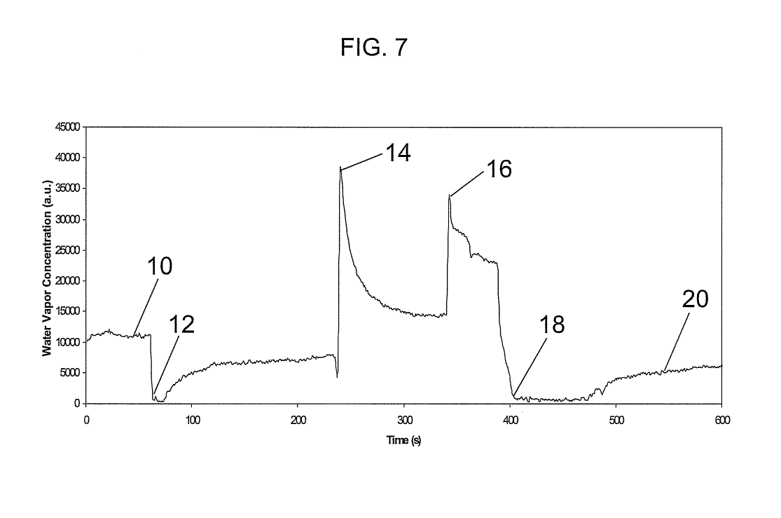

Once the absorption spectra were measured as described in Example 1, the laser wavelength was set to the main water vapor absorption peak wavelength. The detection system described in Example 1 was then used to perform continuous monitoring of water vapor concentration. FIG. 7 shows a plot of measured water vapor concentration as a function of time. Specifically, FIG. 7 shows a plot of measured water vapor concentration over time as the detection system was sequentially subjected to varying conditions. Over the time range indicated in FIG. 7, the detection system was sequentially exposed to normal lab humidity (with the measured response indicated by 10), a first nitrogen (N₂) purge (with the measured response indicated by 12), a first human breath (with the measured response indicated by 14), a second human breath (with the measured response indicated by 16), a second N₂ purge (with the measured response indicated by 18), and finally to the open air (with the measured response indicated by 20).

### Example 3

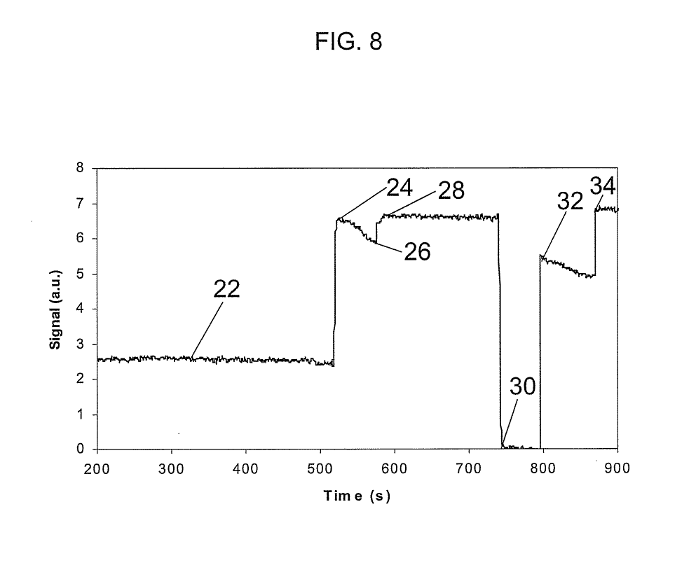

A photoacoustic gas detection system included a DFB laser diode as a laser source, an acoustic resonator, two tuning forks, and a data acquisition and control unit. The DFB laser diode was tuned to operate at a wavelength of 1532 nm (the wavelength of the DFB laser diode can be tuned by changing its package temperature) so as to determine the concentration of C₂H₂ as the target gas (C₂H₂ was selected as a target gas because it has strong absorptions around 1.5 μm). The resonator and turning fork are the same type as described in Example 1. The beam from the laser diode fiber was collimated and focused with two separated lenses to the resonator. Prior to taking target gas concentration measurements, the tuning fork resonance frequency was measured using a function generator and a lock-in amplifier. Then, the laser diode was modulated at a half of the tuning fork resonance frequency. Next, the tuning fork signal was monitored while the laser diode temperature was tuning Once the signal reached its maximum value, the temperature setting was used for the remaining experiments. This process can be performed rapidly with the control unit. Using these settings, the concentration of C₂H₂ was measured over time, as shown in FIG. 8.

The plot shown in FIG. 8 illustrates the ability of the detection system to calibrate itself. Specifically, FIG. 8 shows a plot of measured C₂H₂ concentration over time as the detection system was sequentially subjected to varying conditions. Over the time range indicated in FIG. 8, the detection system was sequentially exposed to a first C₂H₂ concentration of less than about 2 ppm (with the measured response indicated by 22), an increase in C₂H₂ concentration to about 10 ppm (with the measured response indicated by 24), a change in the pressure from about 510 Torr to about 434 Torr (with the initial measured response indicated by 26), an air purge (with the measured response indicated by 30), and a second introduction of C₂H₂ at a concentration of about 10 ppm at about 400 Torr (with the initial measured response indicated by 32). When the pressure was changed, the detection system was able to self-calibrate (as shown by the measured response indicated by 28 and 34) where a C₂H₂ concentration of about 10 ppm was measured over differing pressure conditions. Specifically, 26 and 32 in FIG. 8 show that the measured signal strength changed following a pressure change even though the actual C₂H₂ concentration did not change. This is because tuning fork frequency is dependent on pressure. Once the pressure is changed, the laser modulation frequency is not synchronized with the tuning fork anymore. To overcome this effect, we remeasured the tuning fork resonance frequency and used it as laser modulation frequency. As can be seen in FIG. 8, the measured concentration values after calibration (indicated by 28 and 34) are in agreement with the original measured value (indicated by 24). This recalibration process was performed with a PC and repeated several times, thereby illustrating self-calibration. In addition, a sensitivity of 10 ppm or less is demonstrated.

### Example 4

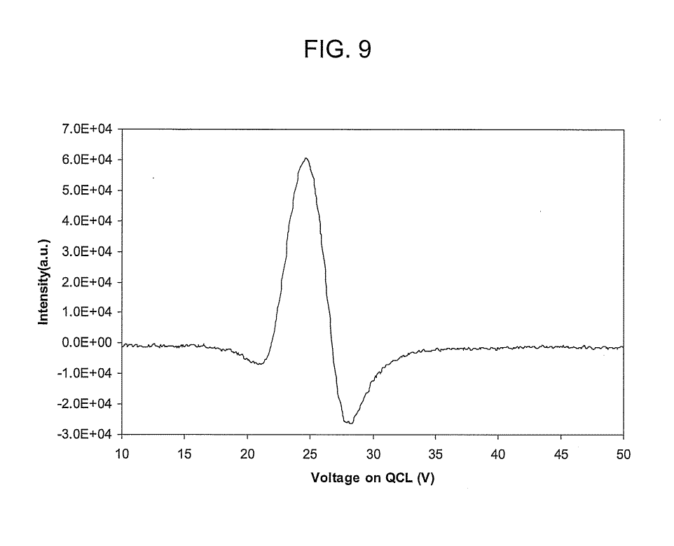

We have also successfully demonstrated better than 50 ppm sensitivity for nitric oxide (NO) gas, wherein the signal to noise ratio was estimated to be about 230. The wavelength used in the experiment was optimized to the strong NO absorption peak with minimal water absorption. FIG. 9 shows a plot of a measured absorption spectrum over a tuning range of about 0.4 cm-1 while the laser was modulated at ˜16 kHz using the method described above with respect to Example 1. The asymmetric valleys shown in FIG. 9 are due to residual wavelength modulation during wavelength tuning.

It will be apparent to those skilled in the art that various modifications and variations can be made without departing from the spirit and scope of the invention.

What is claimed is:

1. A photoacoustic gas detector for detecting the concentration of at least one target gas, the gas detector comprising:
a laser source;
a resonator extending along a longitudinal axis, the resonator having a first end, a second end, and an inner cavity between the first end and the second end, the inner cavity extending along the longitudinal axis and defining a longitudinal opening between the first end and the second end, the inner cavity adapted to allow a laser beam from the laser source to pass through the longitudinal opening; and
at least one tuning fork positioned along a longitudinal length of the resonator, said tuning fork comprising a first prong and a second prong, wherein the longitudinal axis does not intersect an area between the first prong and the second prong.

2. The gas detector of claim 1, wherein the resonator comprises a cylindrical tube.

3. The gas detector of claim 1, wherein the first prong and the second prong are generally parallel to the longitudinal axis.

4. The gas detector of claim 1, wherein the first prong and the second prong are generally perpendicular to the longitudinal axis.

5. The gas detector of claim 1, wherein the gas detector is capable of detecting at least one target gas at a concentration of less than 200 parts per million.

6. The gas detector of claim 1, wherein the resonator has a structural resonance frequency that substantially coincides with a structural resonance frequency of the tuning fork.

7. The gas detector of claim 1, wherein said resonator and said tuning fork are integrated on a single platform.

8. The gas detector of claim 1, wherein said resonator has a parabolic cross section and the tuning fork is at least partially positioned on a focal point of the parabolic cross section.

9. The detector of claim 1, wherein the detector is capable of detecting the concentration of at least two target gases.

10. The detector of claim 1, wherein the at least one tuning fork comprises at least two tuning forks.

11. A method for determining the concentration of at least one target gas using photoacoustic detection, the method comprising:
directing a laser beam from a laser source into an inner cavity of an acoustic resonator, the resonator and the inner cavity extending along a longitudinal axis, the inner cavity containing a concentration of the at least one target gas, wherein interaction between the laser beam and the at least one target gas causes accumulation of an acoustic signal in the resonator;
generating a resonant absorption signal relative to the concentration of the at least one target gas by at least one tuning fork positioned along a longitudinal length of the resonator, said tuning fork comprising a first prong and a second prong, wherein the longitudinal axis does not intersect an area between the first prong and the second prong.

12. The method of claim 11, wherein the resonator comprises a cylindrical tube.

13. The method of claim 11, wherein the method is capable of detecting at least one target gas at a concentration of less than 200 parts per million.

14. The method of claim 11, wherein the resonator has a structural resonance frequency that substantially coincides with a structural resonance frequency of the tuning fork.

15. The method of claim 11, wherein the resonant absorption signal is at least 10 times greater than a background noise signal.

16. The method of claim 11, wherein the at least one tuning fork comprises at least two tuning forks.

17. The method of claim 16, wherein the method is capable of generating a resonant absorption signal relative to the concentration of the at least one target gas while calibrating for the temperature and pressure in the inner cavity of the resonator.

18. The method of claim 11, wherein the method is capable of generating a resonant absorption signal relative to the concentration of the at least one target gas within one second of first directing the laser beam from the laser source into the inner cavity of the resonator.

19. The method of claim 11, wherein the method is capable of generating a resonant absorption signal relative to the concentration of the at least one target gas at a temperature of at least 700° C.

20. The method of claim 11, wherein the laser source produces at least one emission wavelength with a spectral linewidth narrower than the absorption bandwidth of the gas.

21. The method of claim 11, wherein the laser source is capable of tuning its wavelength to find the absorption peak of the at least one target gas.
